(19) United States
(12) Patent Application Publication
(10) Pub. No.: US 2023/0225359 A1
(43) Pub. Date: Jul. 20, 2023

(54) OILSEED PROCESSING USING ALCOHOLS OR NONPOLAR SOLVENTS

(71) Applicant: Colby Stoppelbein, Warsaw, NC (US)

(72) Inventor: Colby Stoppelbein, Warsaw, NC (US)

(21) Appl. No.: 17/579,735

(22) Filed: Jan. 20, 2022

(51) Int. Cl. A23J 1/14; A23L 11/30; A23L 11/00; B01D 11/02

(52) U.S. Cl. CPC A23J 1/144; A23L 11/07; A23L 11/32; B01D 11/028; B01D 11/0288

(57) ABSTRACT

A method of oi seed processing in which an extraction solvent comprising ethyl alcohol is applied in the process of oil extraction. Solvents of similar effect to that of ethyl alcohol may be used in conjunction to produce the desired result. Such a production method yields oil with substantially greater o l stability. As a result of oil extraction and processing, the subsequent meal is of increased palatability for animal and human consumption. Through such extraction and processing methods oil and meal are free of residue and undesirable characteristics commonly associated with other traditional methods of oil extraction.

### BACKGROUND

Nutritionists, commonly cite poor diet, including the consumption of processed oils, such as those used in fried foods, as a significant contributing factor to heart disease and obesity, among other health concerns. Oilseed for foodstuffs commonly include soybean oil, canola oil, corn oil, and peanut oil. More detail is given in the present application to soybean processing because of its greater relative importance to the vegetable oil industry, though embodiments may apply to all types of oilseed and oil processing in general.

Soybean oil production, in particular, typically includes elevator operations that comprise receiving, storing, and cleaning raw soybeans. The soybeans are typically prepared for solvent solution and oil desolventizing. Oil refining is performed, and the spent flakes are desolventized and otherwise processed.

More specifically, the extraction process includes extracting oil for soybeans the oil from soybean, and ultimately, with pure hexane. The oil and hexane may be partially removed from an extractor separately from the defatted flakes. In some instances, a desoventizer-toaster is used to evaporate some of the hexane from the flakes. In applications for human food, rather than animal feeds, the flakes may be treated with a superheated hexane solvent.

### SUMMARY

According to a particular embodiment, a method of oilseed processing may include applying a solution solvent comprising ethyl alcohol that produces an oilseed mixture comprising meal and oil. The method further may include separating the meal from the oil. The resultant meal of this process may constitute broader applications in the animal feed and meal markets than these using hexane as the solution solvent.

According to another particular embodiment, a method of oilseed processing may include applying a solvent solution over oilseed, where the solvent solution includes at least one of a nonpolar solvent and ethyl alcohol. The application of the solvent solution may produce an oilseed mixture comprising meal and oil. The method may further include separating the solvent solution from the oil, and refining the oil. Such a method of oilseed processing and refining of the oil yields a product with substantially greater stability

According to another particular embodiment, a method of oilseed processing includes presenting a plurality of flakes that include oilseed, and applying a solvent solution over the plurality of flakes, where the solvent solution includes at least one of a nonpolar solvent and ethyl alcohol. The application of the solvent solution produces an oilseed mixture comprising meal and oil. The method further may include separating the meal from the oil.

According to another particular embodiment, a method of oilseed processing may include applying a solvent solution over the plurality of flakes, where the solvent solution includes at least one of a nonpolar solvent and ethyl alcohol. The application of the solvent solution may produce an oilseed mixture comprising meal and oil. The method may further include separating the solvent solution from the oil, and refining the oil.

According to another particular embodiment, a method of oilseed processing may include desolventizing a plurality of flakes comprising oilseed, where a desolventizing extraction includes at east one of ethyl alcohol and a nonpolar solvent, applying heat to the plurality of flakes, and cooling the flakes.

The above description is provided as an overview of only some implementations disclosed herein. Those and other implementations are described in more detail here.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram is an embodiment of a system that adds an alcohol or a nonpolar solvent at any one of multiple points during a soybean processing production; and

FIG. 2 is a flowchart of an embodiment of a method of performing oilseed processing that includes adding a solvent to a soybean mixture, wherein the solvent includes at least one of ethyl alcohol and a nonpolar solvent.

### DETAILED DESCRIPTION

A method of oilseed processing may use an extraction solvent comprising ethyl alcohol that is applied in the process of oil extraction. Solvents of similar effect to that of ethyl alcohol may be used in conjunction to produce the desired result. Such a production method yields oil with substantially greater oil stability. Oil may be extracted from oilseed by using ethyl alcohol as the solvent, and the extracted oil is thus desolvetized in a manner that results in diminished amounts of or an absence of a residual solvent.

As a result of oil extraction and processing, the subsequent meal is of increased palatability for animal and human consumption. Through such extraction and processing methods oil and meal are free of residue and undesirable characteristics commonly associated with other traditional methods of oil extraction (e.g., that involve hexane-based extraction solvents.

An embodiment of the system and associated method may include introducing a nonpolar solvent or ethyl alcohol as an extraction solvent in oilseed processing and extraction techniques. A particular embodiment may replace hexane with ethyl alcohol as a solvent for soybean oil extraction.

According to an illustrative embodiment, an extraction solvent blend may include a solvent alcohol that has been denatured with a nonpolar solvent, such as diethyl ether. The denatured product may be introduced in an extraction process as the extraction solvent. In another example, a process includes a nonpolar solvent, such as ethyl alcohol, as the extraction solvent in the extraction process.

Embodiments may use existing soybean processing machinery, thus avoiding costs associated with reconfigurations and significant equipment acquisitions. While embodiments described herein are in the context of soybean processing, the principles described herein may apply to other types of oilseed. Certain embodiments may be used in any refining or processing application, even unrelated to oilseed. Processing operations for soybean oil, canola oil, canola oil, corn oil, and peanut oil are very common. More detail is given to soybean processing because of its greater relative importance to the vegetable oil industry.

Although pure ethyl alcohol or nonpolar solutions may be used as a solvent, other embodiments explained herein may include ethyl alcohol or nonpolar solutions that are combined with other solvents to achieve a desired effect.

In an example of soybean meal hexane residue extraction, a process includes introducing a nonpolar solvent, such as ethyl alcohol, as the extraction solvent in the extraction process. Alcohol may be introduced to soybean meal containing residual hexane. Soybean meal may be saturated in equally proportionate levels of alcohol to meal. Once the meal has fully absorbed the alcohol, the meal may then be dried revealing the absence of both the solvent alcohol and hexane.

According to another particular embodiment, a process includes introducing a solvent alcohol to soybean meal containing hexane to remove hexane from the meal after oil extraction.

Some applications of the processes and products associated with embodiments disclosed herein may relate to medical treatment plans, to include diet.

Within this context, the replacement of hexane by ethanol (either hydrous or anhydrous) as solvent for soybean oil extraction may be realized. An embodiment of a method may include introducing a nonpolar solvent or ethyl alcohol as an extraction solvent in oilseed processing and extraction techniques.

An example of an extraction solvent blend may include a process in which solvent alcohol is denatured with a nonpolar solvent as the extraction solvent. In another example, a process in which hexane is denatured with a nonpolar solvent, such as alcohol, which is introduced in the extraction process as the extraction solvent. In still another example, a process includes introducing a nonpolar solvent, such as ethyl alcohol, as the extraction solvent in the extraction process.

While an extraction solvent consisting of ethyl alcohol or a nonpolar solvent may be advantageous (e.g., containing no hexane), other embodiments may include a solvent comprising either or both ethyl alcohol and a nonpolar solvent, as well as hexane or other compounds. While such embodiments of solvents are contemplated, a hexane-free product is possible using either ethyl alcohol and a nonpolar solvent in the absence of hexane.

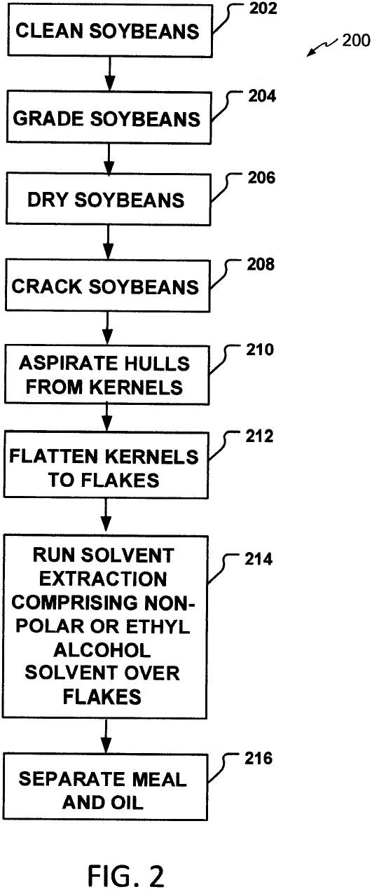

FIG. 1 is an embodiment of a system 100 that may introduce a nonpolar solvent or ethyl alcohol as an extraction solvent in oilseed processing and extraction techniques. A specific example of an extraction solvent blend may include a process in which solvent alcohol is denatured with a nonpolar solvent, such as diethyl ether, and introduced in the extraction process as the extraction solvent. In another example, a nonpolar solvent, such as ethyl alcohol, may comprise the extraction solvent in the extraction process. In some instances, the system 100 may use existing soybean processing machinery, thus avoiding costs associated with reconfigurations and significant equipment acquisitions. While the system 100 is configured for soybean processing, or systems are contemplated for other types of oilseed. Additionally, one or more machines of other embodiments may be added or removed from a system in relation to the illustrative system 100 of FIG. 1.

Turning more particularly to FIG. 1, a grading machine 102 may grade soybeans based on weight, moisture, protein content, and oil content, among other factors. In one example, the grading machine 102 uses infrared spectroscopy for the sorting.

Screeners of a cleaning machine 104 may receive soybeans to remove foreign materials and weed seeds. The soybeans may be stored or flash dried with heat at a drying machine 106 to dry the soybeans down to an acceptable moisture level.

Large rollers of a cracking machine 108 may crack the soybeans into small pieces. An aspirator machine 110 may use air flow to separate hulls from kernels. Other rollers at a flaking machine 112 m ay flatten the kernels into flakes to increase surface area and disrupt oil cell structure.

At an extracting machine 114, an embodiment of the system 100 may introduce a solvent that includes a: least one of ethyl alcohol and a nonpolar solvent. The solvent may be run over the flakes to extract oil.

According tc a particular embodiment, the solvent (i.e., ethyl alcohol or the nonpolar solvent) may be mixed in equal parts with the soybean mixture. In another example, the amounts of solvent and soybean mixture may be mixed in different ratios. For instance, the amount (e.g., by volurr e or weight) of the solvent may be up to 25% more or less than the amount of soy bean mixture.

According to the same or another embodiment, the solvent may comprise ethyl alcohol or the nonpolar solvent, in addition to another solvent. In an embodiment where hexane is additionally used, the ethyl alcohol or nonpolar solvent may function to reduce or eliminate the residual hexane.

In the embodiment of FIG. 1, the system 100 splits the meal from the oil down different paths after the extracting machine 114. Along the oil path of the system 100, the oil may be stripped from the extractor at a stripping machine 116. The oil may take the form of micella, a combinatior of oil and solvent.

A distilling machine 118 may separate the solvent from the oil. The oil may comprise crude soybean oil at this stage.

Lecithins and other gums may be removed from the oil at 120. The oil may be classified as degummed soybean oil at this stage.

Along the meal, or flake, path 117 of the system 100, a desolventizer-toaster-dryer-cooler (DTDC)122 may be provided. Toasting may remove unwanted material, and drying may optimize moisture. Cooling processes may get the meal flakes close to ambient temperature.

The meal may be sized using a series of screens at a sizing machine 124, and the final meal product may be tested at an evaluation machine 128. The meal may be tested for levels of fat and fiber, among; other characteristics.

As explained herein, the configuration of the system 10 is merely illustrative, and several of the machines 102, 104, 106, 108, 110, 112, 114, 116, 118, 120, 121, 122, 124, 126, and 128 may be reordered or omitted in other embodiments. Likewise, other machines may be added depending on the application. In particular, the extracting machine 114 or another module responsible for introducing solvent comprising ethyl alcohol or a nonpolar solvent could be moved to proximate or at any of the machines 116, 118, 120, 121, 122, 124, 126, and 128 where desired. For instance, repositioning the extracting machine of another embodiment may be advantageous for space, energy, manpower, or efficiency considerations.

Moreover, while the system 100 is shown in a configuration having particular application for soybean processing, other types of oilseed processing may similarly benefit from the techniques and solvents of the embodiments explained herein. For instance, canola oil processing may include prepressing canola meal. Corn oil processing may include machine to wet and dry mill co n prior to corn germ separation. Peanut oil processing may include additional cooking and prepressing machines. Still other embodiments may apply the method explained herein to ap plications outside of oilseed.

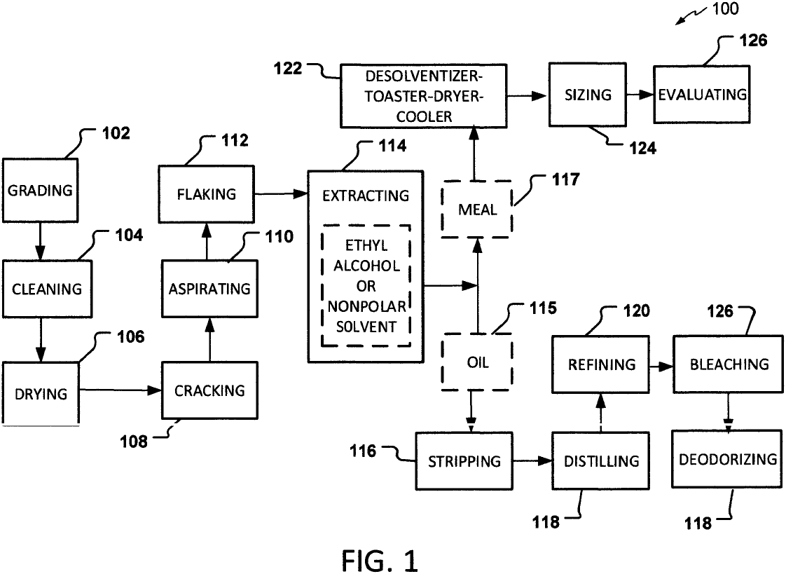

FIG. 2 is a flowchart of an embodiment of a method 200 of performing oilseed processing. The method 200 may be performed by the illustrative embodiment of the system 100 of FIG. 1. More particularly, the steps of the flowchart may roughly correspond to the machines 102, 104, 106, 108, 110, 112, and 114 of the system 100.

Turning more particularly to the steps of the flowchart, the method 200 may include cleaning soybeans at block 202. Related processes may include weighing and cleaning foreign matter and loose hulls. The soybeans may be graded at block 204.

An embodiment of the method 200 may dry the soybeans at 206. The soybeans may be cracked at 208.

At 210, hullsmay be aspirated from the kernels. The kernels may be flattened to flakes at 212.

At 214, a so vent comprising an alcohol (e.g., ethyl alcohol) or a nonpolar solvent may be run over the flakes. The solvent may function to wash the oil from the soybean flakes.

The method 200 may separate the meal from the oil at 216. The oil may be desolventized after being separated using steam to separate the oil from the condensate.

A solvent extraction method of oilseed processing of oilseeds in such a manner that oil is extracted using an extraction solvent comprising ethyl alcohol or a nonpolar solvent. The oilseeds are cleaned, dried, dehulled, cracked, toasted and further prepared for oil extraction. The oilseeds are introduced to the oil extraction phase of processing, for instance by using ethyl alcohol as an extraction solvent. The extracted oil is then desolvetized resulting in the absence of residual solvent.

A solvent extraction method of oilseed processing may include an extraction solvent comprising ethyl alcohol. The solvent is used to extract oil from oilseed in which the resultant oil product is of greater stability. The oilseeds are processed and extracted using an extraction solvent comprising ethyl alcohol in the extraction phase of processing. The extracted oilseed oil is further processed and refined.

A solvent extraction method of oilseed processing in which oil is extracted with the use of an extraction solvent comprising ethyl alcohol resulting in an oilseed meal that is of greater palatability for human and animal consumption. The oil from oilseed is extracted using an extraction solvent comprising ethyl alcohol. The oil and meal are separated following oil extraction. The meal from the oil extraction phase of processing is separated from the oil. The meal is further processed through desolventizing resulting in absence of residual solvent. The meal is then toasted and dried, followed by cooling.

A solvent extraction method of oilseed processing may use an extraction solvent comprising ethyl alcohol or nonpolar solvent solutions that are combined to achieve the desired meal and oil characteristics. Oilseeds are cleaned, dried, dehulled, cracked, toasted and further prepared for oil extraction. The oilseeds are introduced to the oil extraction phase of processing. The oil is extracted from oilseed with the use of ethyl alcohol or nonpolar solvent solutions as th e extraction solvent. The extracted oil is then desolventized, resulting in the reduction or absence of residual solvent.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method of oilseed processing, the method comprising:
providing oilseed;
applying a solvent solution comprising at least one of ethyl alcohol and a nonpolar solvent to the oilseed, wherein application of the solvent solution produces an oilseed mixture comprising meal and oil; and
separating the oil and the meal.

2. The method of claim 1, wherein oilseed is cleaned, dried, dehulled, cracked, and toasted.

3. The method of claim 1, wherein the oilseed is introduced to an oil extraction phase of processing.

4. The method of claim 1, wherein the extracted oil is desolventized with an absence of residual solvent.

5. The method of claim 1, wherein the extracted oil comprises increased stability as compared to oil extracted without using the ethyl alcohol.

6. The method of claim 1, further comprising aspirating a plurality of hulls from a plurality of kernels.

7. The method of claim 1, wherein the oilseed includes at least one of: soybean, sunflower, Brassica, canola, rapeseed, and peanuts, and wherein the non-polar solvent includes at least one of: hexane, xylene), and diethyl ether.

8. The method of claim 1, further comprising flattening a plurality of kernels into the plurality of fakes.

9. The method of claim 1, further comprising stripping the oil from an extractor.

10. The method of claim 1, further comprising performing distillation.

11. The method of claim 1, further comprising deodorizing an odor from the oil.

12. The method of claim 1, further comprising processing the meal through desolventizing, resulting in absence of residual solvent.

13. An oilseed product comprising:
at least one of meal and oil, wherein the oilseed product is formed by applying a solvent solution to oilseed, wherein the solvent solution includes at least one of ethyl alcohol and a nonpolar solvent, and wherein application of the solvent solution produces an oilseed mixture comprising meal and the oil, and wherein the oil is separated from the meal to realize the oilseed product.

14. The oilseed product of claim 13, further comprising an extractor from which the oilseed is stripped.

15. The oilseed product of claim 13, wherein a distillation is performed on the oilseed.

16. The oilseed product of claim 13, wherein the oilseed is deodorized.

17. The oilseed product of claim 13, wherein the oilseed product is hexane-free.

18. The oilseed product of claim 13, wherein oilseed is cleaned, dried, dehulled, cracked, and toasted.

19. The oilseed product of claim 13, wherein the oilseed is introduced to an oil extraction phase of processing.
